(19) United States
(12) Patent Application Publication
(10) Pub. No.: US 2026/0316392 A1
(43) Pub. Date: Oct. 15, 2026

(54) MANAGING FABRICATION OF TEXTURED THREE-DIMENSIONAL (3D) PRINTED OBJECTS

(71) Applicant: International Business Machines Corporation, Armonk, NY (US)

(72) Inventors: Neil DELIMA, Scarborough (CA); Sarbajit Kumar RAKSHIT, Kolkata (IN); Carolina GARCIA DELGADO, Zapopan (MX); Tushar AGRAWAL, West Fargo, ND (US)

(21) Appl. No.: 19/179,900

(22) Filed: Apr. 15, 2025

(51) Int. Cl. B29C 64/386; B33Y 50/00

(52) U.S. Cl. CPC B29C 64/386; B33Y 50/00

(57) ABSTRACT

In some implementations, a computer may generate a digital model of an object that is to be printed by a three-dimensional (3D) printing device, wherein the object is to have a textured surface. The computer may use the digital model to analyze a surface curvature of the object. The computer may determine, based on the surface curvature, one or more first portions of the object where the 3D printing device is to be used to produce the textured surface. The computer may determine, based on the surface curvature, one or more second portions of the object where a material comprising a texture is to be added to the object to produce the textured surface. The computer may generate an output identifying the one or more first portions and the one or more second portions, wherein printing of the object by the 3D printing device is based on the output.

### BACKGROUND

This disclosure relates to computing systems, and more specifically, to the management of the fabrication of textured three-dimensional (3D) printed objects.

### SUMMARY

Some aspects described herein relate to a method. The method may include generating a digital model of an object that is to be printed by a 3D printing device, where the object is to have a textured surface. The method may include using the digital model to analyze a surface curvature of the object. The method may include determining, based at least in part on the surface curvature, one or more first portions of the object where the 3D printing device is to be used to produce the textured surface. The method may include determining, based at least in part on the surface curvature, one or more second portions of the object where a material comprising a texture is to be added to the object to produce the textured surface. The method may include generating an output identifying the one or more first portions and the one or more second portions, where printing of the object by the 3D printing device is based at least in part on the output.

Some aspects described herein relate to a computer system. The computer system may include a processor set, one or more computer-readable storage media, and program instructions stored on the one or more computer-readable storage media to cause the processor set to perform operations. The operations may include determining a surface curvature of a plurality of regions of an object that is to be 3D printed. The operations may include identifying a first region of the plurality of regions having a first surface curvature. The operations may include identifying a second region of the plurality of regions having a second surface curvature. The operations may include generating an output indicating that the textured surface is to be 3D printed on the first region. The operations may include generating an output indicating that the textured surface is to be created on the second region by securing a sheet material to the second region.

Some aspects described herein relate to a computer program product. The computer program product may include one or more computer-readable storage media and program instructions stored on the one or more computer-readable storage media to perform operations. The operations may include analyzing, using one or more computer vision techniques, a curvature of a surface of an object. The operations may include identifying, based at least in part on the analyzing, a plurality of portions of the object having different degrees of curvature from each other. The operations may include identifying, based at least in part on a first degree of curvature, a first portion of the plurality of portions having a first textured surface that is to be 3D printed. The operations may include identifying, based at least in part on a second degree of curvature, a second portion of the plurality of portions having a second textured surface.

### BRIEF DESCRIPTION OF THE DRAWINGS

FIG. 1 is a diagram of an example computing environment for managing fabrication of textured 3D printed objects described herein.

FIG. 2 is a block diagram of an example implementation associated with fabricating a 3D printed object having a textured surface.

FIG. 3A illustrates an example implementation of an object that is to be 3D printed.

FIG. 3B illustrates an example implementation of the object that is to be 3D printed, where a first portion of the object and multiple second portions of the object are identified.

FIG. 4 illustrates an example implementation of a sheet material that may be fabricated by the sheet material fabrication system.

FIG. 5 illustrates an example implementation of a 3D printed object.

FIG. 6 is a flowchart of an example process associated with managing fabrication of textured 3D printed objects.

FIG. 7 is a flowchart of an example process associated with managing fabrication of textured 3D printed objects.

FIG. 8 is a flowchart of an example process associated with managing fabrication of textured 3D printed objects.

### DETAILED DESCRIPTION

The following detailed description of example implementations refers to the accompanying drawings. The same reference numbers in different drawings may identify the same or similar elements.

3D printing is a versatile and innovative technology. However, it comes with certain challenges when creating surface textures, such as longer manufacturing times and increased costs. These challenges may be caused by several factors, including the need for extremely high layer resolutions to achieve fine details in surface texture, slower print speeds, and requirements for specialized materials or equipment.

Current methods of achieving complex surface textures involve additional post-processing steps following 3D printing of textured surfaces, such as sanding, painting, or other finishing techniques. These steps add both time and cost to the production process, highlighting the need for a more efficient and cost-effective method of creating surface textures in 3D printing.

Some implementations described herein provide a method for creating an object with a textured surface using a combination of 3D printing and sheet material fabrication. For example, a digital model of an object that is to be 3D printed is generated, and the surface curvature of the object is analyzed using the digital model. The analysis is used to determine which portions of the object can be printed with the textured surface using the 3D printing device and which portions of the object require the addition of a material comprising the texture to a surface of the 3D printed object. The material comprising the texture may be fabricated separately from the 3D printed object using, for example, a sheet material fabrication device.

In this way, the method optimizes fabrication resource utilization by allocating tasks to the 3D printing device and the sheet material fabrication device according to their respective functionalities, thereby conserving processing resources and reducing fabrication time. The method also minimizes the need for post-processing steps, which can reduce the object’s production latency and conserve resources that would have otherwise been consumed by additional processing tasks. Furthermore, the method enables precise control over texture and material properties, allowing for the creation of complex surface textures with improved accuracy and consistency.

Thus, the method may conserve processing resources, memory resources, and/or other resources that would have otherwise been consumed by manual post-processing, multiple fabrication iterations, and/or other issues. The method’s efficiency and precision also enable it to be applied to a variety of technical domains, including manufacturing, aerospace, automotive, and healthcare, where objects with complex surface textures are often required.

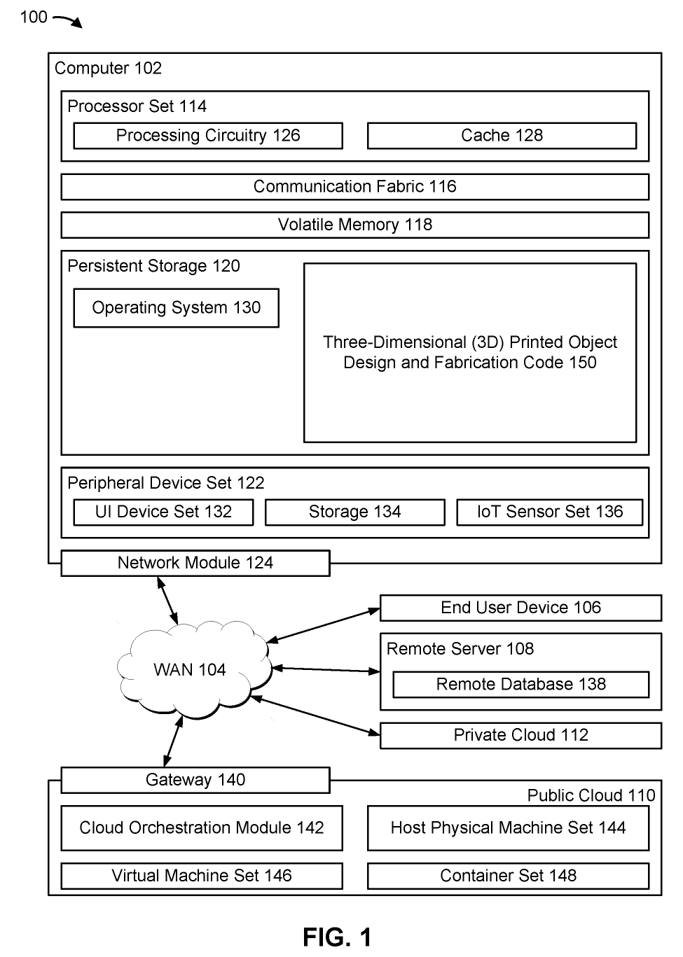

FIG. 1 is a diagram of an example computing environment 100 for managing fabrication of textured 3D printed objects described herein.

The computing environment 100 contains an example of an environment for the execution of at least some of the computer code involved in performing the inventive methods, such as 3D printed object design and fabrication code 150. In addition to the 3D printed object design and fabrication code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the 3D printed object design and fabrication code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in 3D printed object design and fabrication code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input / output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the 3D printed object design and fabrication code 150 typically includes at least some of the computer code involved in performing one or more operations described herein. In some implementations, the operations may include generating a digital model of an object that is to be printed by 3D printing device, wherein the object is to have a textured surface; using the digital model to analyze a surface curvature of the object; determining, based at least in part on the surface curvature, one or more first portions of the object where the 3D printing device is to be used to produce the textured surface; determining, based at least in part on the surface curvature, one or more second portions of the object where a material comprising a texture is to be added to the object to produce the textured surface; and generating an output identifying the one or more first portions and the one or more second portions, wherein printing of the object by the 3D printing device is based at least in part on the output.

In some implementations, the operations may include determining a surface curvature of a plurality of regions of an object that is to be 3D printed, wherein the object comprises a textured surface, and wherein the determining comprises computing a curvature of a plurality of points on a digital model of the object; identifying a first region of the plurality of regions having a first surface curvature; identifying a second region of the plurality of regions having a second surface curvature, wherein the second surface curvature is smaller than the first surface curvature; generating an output indicating that the textured surface is to be 3D printed on the first region; and generating an output indicating that the textured surface is to be created on the second region by securing a sheet material to the second region, wherein a surface of the sheet material has a texture corresponding to the textured surface.

In some implementations, the operations may include analyzing, using one or more computer vision techniques, a curvature of a surface of an object; identifying, based at least in part on the analyzing, a plurality of portions of the object having different degrees of curvature from each other, wherein each the plurality of portions has a textured surface; identifying, based at least in part on a first degree of curvature, a first portion of the plurality of portions having a first textured surface that is to be 3D printed; and identifying, based at least in part on a second degree of curvature, a second portion of the plurality of portions having a second textured surface, wherein the second textured surface is to be manufactured separately from the second portion and affixed to the second portion.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

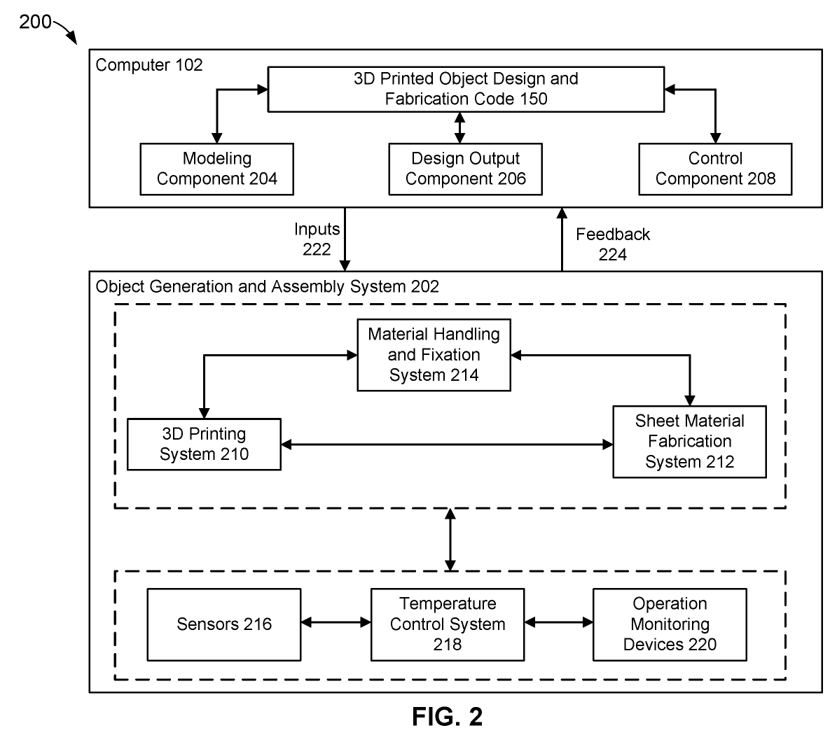

FIG. 2 is a block diagram of an example implementation 200 associated with fabricating a 3D printed object having a textured surface. As shown in FIG. 2, example implementation 200 includes a computer 102 that utilizes the 3D printed object design and fabrication code 150. The 3D printed object design and fabrication code 150 is used to design and manage fabrication of a 3D printed object having a textured surface. Generation and assembly of the 3D printed object may be performed by the object generation and assembly system 202.

The 3D printed object design and fabrication code 150 includes a modeling component 204 that is used to generate a digital model of the object. The modeling component 204 uses the digital model to analyze a surface curvature of the object. In some implementations, the modeling component 204 generates a mesh model of the object, and uses the mesh model to analyze the surface curvature of the object. The modeling component 204 may apply one or more computer vision and/or image analysis techniques to the mesh model to identify a level of the surface curvature for one or more areas of the object. In some implementations, computer vision and image analysis techniques can be employed to analyze the surface curvature and profile of a digital 3D model by treating the 3D model as a 2D representation, such as a mesh or a point cloud, and then applying various algorithms to extract relevant features.

In a pre-processing step, the 3D model is converted into a suitable format, such as a mesh or a point cloud, to facilitate analysis. This may involve reducing the model’s complexity, removing noise, and/or filling gaps in the data. Computer vision techniques, such as edge detection, corner detection, and/or feature point extraction (e.g., a scale-invariant feature transform (SIFT) algorithm, or a speeded up robust features (SURF) algorithm), are applied to the 2D representation of the 3D model. These features help identify different degrees of curvature (e.g., high, moderate, low), contours, and/or other relevant characteristics.

For example, the modeling component 204 may apply computer vision techniques to the mesh model to compute a plurality of normal vectors for a plurality of points on a surface of the digital model, and to analyze the plurality of normal vectors to compute a curvature at each of the plurality of points. The normal vectors may provide information about the orientation of the surface at each point. This can be done using techniques such as the fast marching method and/or the normal aligned radial feature (NARF) descriptor.

The modeling component 204 may use techniques such as Gaussian curvature, mean curvature, and/or principal curvature to analyze the plurality of normal vectors and/or other local features to compute the curvature at each point. In some implementations, the modeling component 204 may use extracted features, normal vectors, and/or curvature information to analyze the profile of the 3D model. This may include identifying different degrees of curvature, detecting contours, detecting edges, and/or segmenting the model into regions with similar characteristics. The results may be refined and/or filtered to remove noise, reduce errors, and/or enhance the accuracy of the analysis.

In some implementations, convolutional neural networks (CNNs) may be trained to learn features and patterns in 3D models, allowing for more accurate analysis of surface curvature and profile. Point cloud processing may be used to analyze point clouds and/or extract features relevant to surface curvature and profile. A structured light technique may be used to project a light pattern onto a 3D model and analyze the resulting image to extract information about the surface curvature and profile of an object. A photometric stereo technique may use multiple images of a 3D model under different lighting conditions to estimate normal vectors and curvature.

The modeling component 204 determines, based at least in part on the surface curvature, one or more first portions of the object where a 3D printing device of a 3D printing system 210 is to be used to produce a textured surface on the 3D printed object. In some implementations, the 3D printing materials include acrylonitrile butadiene styrene (ABS), polyactic acid (PLA), polyethylene terephthalate glycol (PETG), nylon, thermoplastic polyurethane (TPU), polyvinyl alcohol (PVA), high impact polystyrene (HIPS), carbon fiber, Kevlar, fiberglass, polypropylene, and/or resins, among other materials. In some implementations, selective laser sintering (SLS) and/or binder jetting can be used to create 3D printed objects with surfaces having specific textures, such as lattice patterns and/or honeycomb structures. In some implementations, fused deposition modeling (FDM) and/or stereolithography (SLA) can be used to create flexible 3D printed materials with textured surfaces.

The modeling component 204 also determines, based at least in part on the surface curvature, one or more second portions of the object where a material comprising a texture is to be added to the object to produce the textured surface. In some implementations, the curvature (e.g., surface curvature) of the one or more second portions is smaller than the curvature of the one or more first portions. In other words, the second portions may be flatter than the first portions, where it would be easier to attach sheet material to the flatter second portions than the first portions having a larger curvature. In some implementations, the modeling component 204 identifies a plurality of portions of the object having different degrees of curvature from each other, wherein each the plurality of portions has a textured surface. Based at least in part on a first degree of curvature, the modeling component 204 identifies a first portion of the plurality of portions having a first textured surface that is to be 3D printed, and based at least in part on a second degree of curvature, the modeling component 204 identifies a second portion of the plurality of portions having a second textured surface, wherein the second textured surface is to be manufactured separately from the second portion and affixed to the second portion. The design output component 206 may classify the portions of the object based on the different degrees of curvature. For example, the design output component 206 may classify the portions of the object as having a high curvature, moderate (e.g., medium) curvature, and/or a low curvature. The 3D printing system 210 and/or the sheet material fabrication system 212 may use the classifications to identify the first portion and the second portion.

In some implementations, the material comprising the texture is a material manufactured by a sheet material fabrication system 212. There may be various materials that can be added to a 3D printed object to create a textured surface on the 3D printed object. In some implementations, thermoplastic sheets can be attached to the 3D printed object using adhesives, heat, and/or mechanical fasteners. Thermoplastic sheets can be textured by the sheet material fabrication system 212 using various techniques, such as embossing, etching, or printing. In some implementations, adhesive-backed films can be applied to the 3D printed object. Adhesive-backed films can be textured by the sheet material fabrication system 212 using various techniques, such as embossing, etching, or printing.

In some implementations, materials such as wood, plastic, and/or metal can be laser-etched by the sheet material fabrication system 212 to create textured surfaces with intricate patterns that may be added to a 3D printed object to create a textured surface on the 3D printed object. In some implementations, fabrics, textiles, ceramic plates, metal plates, and/or soft-touch materials such as silicone, rubber, and/or thermoplastic elastomers (TPEs) can be manufactured and textured by the sheet material fabrication system 212. In some implementations, the materials manufactured and textured by the sheet material fabrication system 212 can be applied and/or attached to 3D printed objects using the material handling and fixation system 214 to create textured surfaces on the 3D printed objects.

The design output component 206 may generate an output identifying the one or more first portions of the object where the 3D printing device is to be used to produce the textured surface. The design output component 206 may generate an output identifying the one or more second portions where a material comprising a texture is to be added to the object to produce the textured surface. The control component 208 may use the output(s) generated by the design output component 206 to control the 3D printing process by the 3D printing system 210 and to control material fabrication by the sheet material fabrication system 212. The control component 208 may use the output generated by the design output component 206 to control the application of the textured material generated by the sheet material fabrication system 212 to a 3D printed object.

In some implementations, the modeling component 204 uses a machine learning algorithm to determine the first portions of the object where a 3D printing device of a 3D printing system 210 is to be used to produce a textured surface on the 3D printed object, and to determine the second portion of the object where a material comprising a texture is to be added to the object to produce the textured surface. The machine learning algorithm may be trained with a dataset comprising manufacturing time data, manufacturing cost data, and/or material usage data for a plurality of operations in which objects with textured surfaces were 3D printed. By using the historical data of this dataset, the machine learning algorithm conducts a cost-benefit analysis to determine an optimal combination of 3D printing and sheet material fabrication to generate textured surfaces, which limits time, cost, and/or material.

In some implementations, the modeling component 204 utilizes one or more image segmentation algorithms to divide the digital model into the first portions and the second portions. Image segmentation algorithms may be used to divide a digital image or model into its constituent parts or objects. These algorithms can be applied to identify distinct regions or areas of the model that share similar characteristics. For example, the modeling component 204 may use an edge detection algorithm to identify edges and/or boundaries between different regions of the digital model. The modeling component 204 may use one or more clustering algorithms to group pixels and/or vertices of the model into clusters based on feature similarities such as texture, curvature, and/or other geometries. K-means and hierarchical clustering are some clustering algorithms that may be used. The modeling component 204 may implement CNNs to perform deep-learning-based image segmentation.

In the context of dividing a digital model, these algorithms can be applied to identify regions of the model that have similar surface characteristics, such as texture and/or curvature. For example, a clustering algorithm can group vertices of the model into clusters based on their normal vectors, and then use the clusters to identify distinct regions of the model. In some implementations, the image segmentation algorithms may be used to divide a digital model into portions where surface texture is recommended to be 3D printed and is not recommended to be 3D printed. For example, these algorithms may use a combination of surface curvature analysis and image processing techniques to identify the different portions of the object. The segmentation algorithms may be used to generate a map of the object, highlighting the areas where sheet material is recommended to be applied.

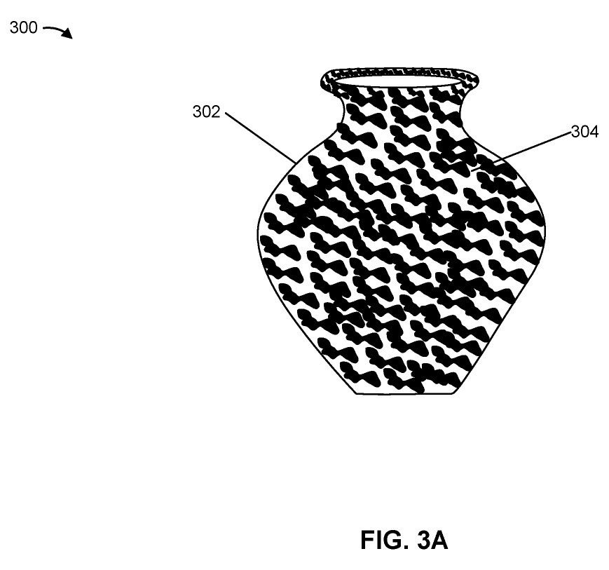

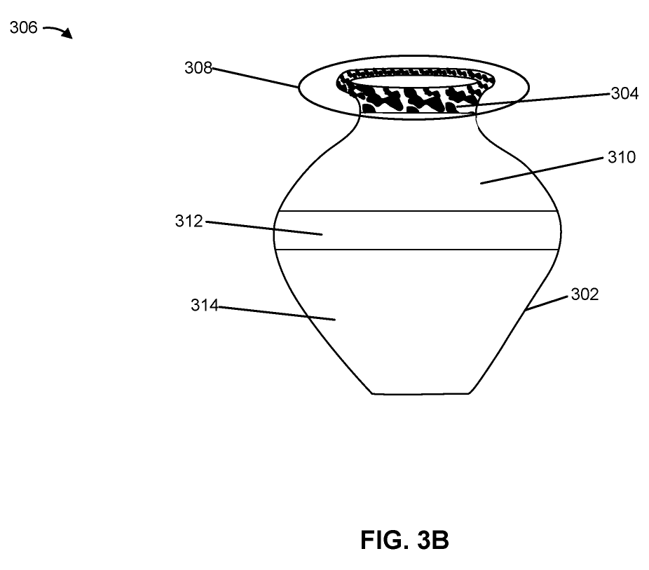

As described in more detail in connection with FIGS. 3A, 3B, 4, and 5, the 3D printing system 210 may be used to 3D print the object based on the identified first and second portions, so that the first portions will be 3D printed with a textured surface and the second portions will be 3D printed without a textured surface. Based on the identified first and second portions, the sheet material fabrication system 212 may be used to fabricate the sheet material with a textured surface, where the sheet material will be configured to be added to the second portions of the object to create the textured surface on the second portions. The material handling and fixation system 214 is used to handle the sheet material and fix the sheet material to the 3D printed objects. For example, in some implementations, the material handling and fixation system 214 may include rollers, presses, and/or clamps to apply pressure to the sheet material when fixing the sheet material to a surface of the 3D printed object to ensure a secure bond. In some implementations, the material handling and fixation system 214 includes one or more devices to heat and/or melt the sheet material so that the heated and/or melted sheet material may be applied to a surface of the 3D printed object to ensure a secure bond.

In some implementations, the design output component 206 and the control component 208 of the 3D printed object design and fabrication code 150 generate object design data and operation control data that is transmitted to the object generation and assembly system 202 in the form of inputs 222. For example, the inputs 222 from the design output component 206 may include data specifying the one or more first portions of the object where a 3D printing device of a 3D printing system 210 is to be used to produce a textured surface on the 3D printed object and data specifying the one or more second portions of the object where a material comprising a texture is to be added to the object to produce the textured surface. For example, based on the inputs 222, the 3D printing system 210 is configured to 3D print the one or more first portions of the object including the textured surface, and to 3D print the one or more second portions of the object without the textured surface. In addition, based on the inputs 222, the sheet material fabrication system 212 is configured to fabricate a material comprising a texture corresponding to the textured surface, so that the material comprising the texture may be added to the one or more second portions of the 3D printed object to create the textured surface.

The inputs 222 from the control component 208 may include, for example, temperature and/or pressure values to be used in connection with the application of the textured material to the 3D printed object, and/or dimensions and/or shapes of the 3D printed object and/or textured material that is to be fixed to the 3D printed object.

The object generation and assembly system 202 includes one or more sensors 216, which may be used to monitor 3D printing operations, material fabrication operations, and/or material fixing operations. For example, the sensors 216 may include pressure and/or temperature sensors to collect temperature data and/or pressure data of the object in connection with the 3D printing operations, material fabrication operations, and/or material fixing operations. The sensors 216 may generate outputs including the temperature and pressure data that are sent to, for example, the temperature control system 218, the 3D printing system 210, the sheet material fabrication system 212, and/or the material handling and fixation system 214 so that these components may control temperature and/or pressure to reach desired ranges during the 3D printing operations, material fabrication operations, and/or material fixing operations. In some implementations, the temperature and pressure data are sent to the control component 208 of the 3D printed object design and fabrication code 150 as feedback 224. Upon receipt of the feedback 224, the control component 208 may control temperature and/or pressure to reach desired ranges during the 3D printing operations, material fabrication operations, and/or material fixing operations.

The object generation and assembly system 202 includes one or more operation monitoring devices 220, such as cameras and/or other image and/or video capturing devices, which may be used to capture images and/or video of a 3D printed object, of the material to be added to the 3D printed object, and/or of the 3D printing operations, material fabrication operations, and/or material fixing operations. The images and/or video may be used by, for example, the 3D printing system 210, the sheet material fabrication system 212, the material handling and fixation system 214, and/or the control component 208 to evaluate whether the quality and/or features of a 3D printed object, fabricated material, and/or combination of a 3D printed object and the fabricated material are within acceptable limits and/or conform to designated specifications. For example, digital image and/or video representations captured by the one or more operation monitoring devices 220 may be evaluated by the 3D printing system 210, the sheet material fabrication system 212, the material handling and fixation system 214, and/or the control component 208 to determine object and textured surface quality, accuracy and/or precision of dimensions, and/or the quality of the attachment of the sheet material to the 3D printed object. Similar to the sensor data, the digital image and/or video representations captured by the one or more operation monitoring devices 220 may be transmitted to the control component as feedback 224. In some implementations, the feedback 224 is used by the modeling component 204 and/or the 3D printed object design and fabrication code 150 to modify the digital model and/or retrain machine learning algorithms used in connection with analyzing the surface curvature and/or identifying the first and second portions.

In some implementations, the sheet material fabrication system 212 may include a robotic system for forming sheet material having the required surface texture into different shapes and/or curvature profiles. For example, the robotic system may use a combination of sensors 216 and actuators to shape the sheet material into the desired form. In addition, the material handling and fixation system 214 may include a robotic system to be used in connection with movement and/or applying the sheet material to the 3D printed object. The 3D printing system 210, sheet material fabrication system 212, and/or the material handling and fixation system 214 may be programmed to communicate with and work in conjunction with each other to ensure seamless integration of the sheet material into the 3D printed object.

The material handling and fixation system 214 may use an adhesive or bonding mechanism to attach the sheet material to the 3D printed object. For example, the adhesive or bonding mechanism may be based on the type of sheet material used, and may be used to ensure a strong bond between the sheet material and the 3D printed object.

The 3D printing system 210, sheet material fabrication system 212, and/or the material handling and fixation system 214 may optimize material usage to minimize waste by saving leftover materials so that the leftover materials can be recycled for other operations. In addition, the 3D printing system 210, sheet material fabrication system 212, and/or the material handling and fixation system 214 may use a combination of sensors and algorithms to track the usage of material and identify areas where waste can be minimized. The modeling component 204 may use machine learning algorithms to predict the amount of material required for a given 3D object and/or material to be added to the 3D object to create a textured surface, and accordingly adjust the manufacturing process through, for example, the control component 208.

Additionally, or alternatively, the modeling component 204 may use threshold values for curvature to determine whether a portion of an object can be 3D printed with a textured surface or requires the textured surface to be formed on a separate sheet material that is to be added to the 3D printed object. For example, the threshold values may be based on the surface curvature of the object, and may be used to classify the portions of the object into different categories based on the surface curvature.

FIG. 2 is provided as an example. Other examples may differ from what is described with regard to FIG. 2.

FIG. 3A illustrates an example implementation 300 of an object 302 that is to be 3D printed, for which a digital model may be generated. As shown in FIG. 3A, the object 302 includes a textured surface 304. As used herein, “textured surface” may refer to a surface that has a deliberate, intentional pattern, and/or arrangement of features, such as ridges, grooves, bumps, and/or other irregularities, which create a specific tactile and/or visual effect. Examples of textured surfaces may include roughened surfaces, embossed surfaces, patterned surfaces, molded surfaces, machined surfaces, and/or engraved surfaces. As shown in FIG. 3A, the object 302 further includes curved sides and/or surfaces, as opposed to flat and/or linear sides and/or surfaces.

FIG. 3B illustrates an example implementation 306 of the object 302 that is to be 3D printed, where a first portion 308 of the object 302, and multiple second portions 310, 312, and 314 of the object 302 are identified. For example, as described herein, the modeling component 204 may identify the first portion 308 and the second portions 310-314 based on their surface curvatures. Based on one or more inputs 222 from the design output component 206 and/or the control component 208, the first portion 308 is to be 3D printed with the surface texture 304 using a 3D printing device (e.g., a 3D printing device of 3D printing system 210). Based on one or more inputs 222 from the design output component 206 and/or the control component 208, the second portions 310-314 are to be 3D printed without the surface texture 304 (e.g., to have a non-textured surface) using a 3D printing device. As used herein, “non-textured surface” may refer to a surface that is substantially smooth, even, and/or uniform, lacking any deliberate or intentional patterns, features, and/or irregularities that would create a specific tactile and/or visual effect. Non-textured surfaces can be characterized by their lack of ridges, grooves, bumps, and/or other surface features that may be found on textured surfaces. The term “non-textured” does not necessarily imply a perfectly smooth or flawless surface. Minor imperfections and/or microscopic irregularities may still be present on a non-textured surface, but these would not be intentionally created to produce a specific texture or pattern. As described herein, the second portions are intended to receive separately fabricated textured material portions to be fixed to the second portions to create the surface texture 304.

The degree of curvature (e.g., surface curvature) of the first portion 308 may be larger than the degrees of curvature of the second portions 313-314, such that fixing separately fabricated textured material portions to the first portion 308 may be difficult, impossible, and/or impractical. As a result, the modeling component 204 may determine that 3D printing the textured surface 304 on the first portion 308 is the optimal method to produce the textured surface 304 on the first portion 308. Because the degrees of curvature (e.g., surface curvature) of the second portions 310-314 may be less than the degree of curvature of the first portion 308, fixing separately fabricated textured material portions to the second portions 310-314 may be the most practical and efficient way to proceed in terms of, for example, manufacturing time, manufacturing cost, and/or material usage. As a result, the modeling component 204 may determine that 3D printing the second portions 310-314 without the textured surface 304 and, instead, fixing separately fabricated textured material portions to the second portions 310-314 is the optimal method to produce the textured surface 304 on the second portions 310-314.

The respective second portions 310, 312, and 314 may be divided according to their relative shapes and curvatures, and/or based on manufacturing constraints associated with the sheet material fabrication system 212 to allow for optimal manufacturing time, manufacturing cost, and/or material usage when manufacturing the textured material portions to be fixed to the second portions 310-314.

FIGS. 3A and 3B are provided as examples. Other examples may differ from what is described with regard to FIGS. 3A and 3B.

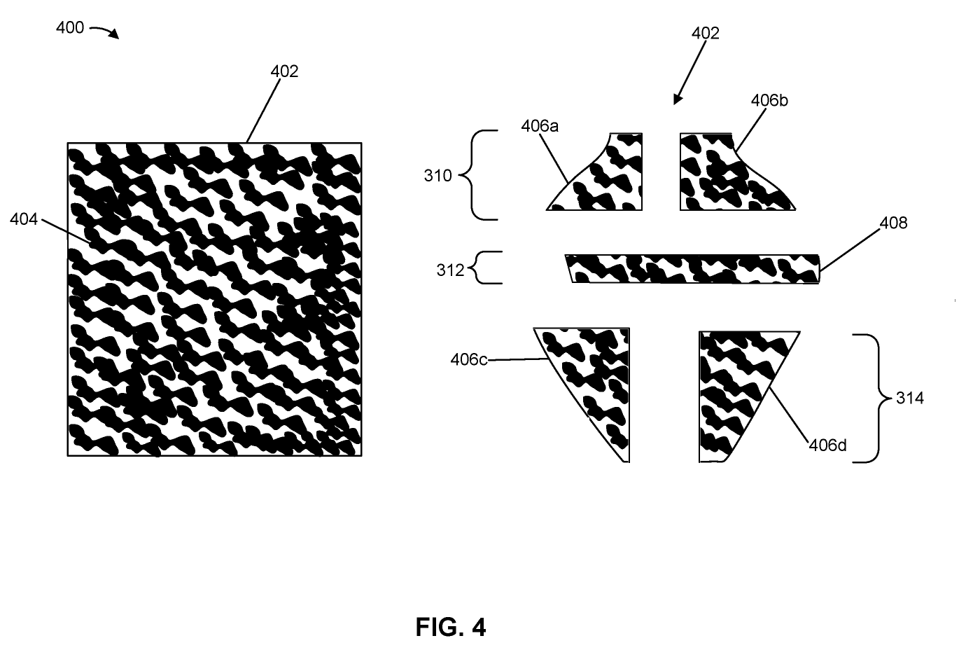

FIG. 4 illustrates an example implementation 400 of a sheet material 402 that may be fabricated by the sheet material fabrication system 212. The sheet material 402 is fabricated by the sheet material fabrication system 212 to include a textured surface 404 that corresponds (e.g., matches) with the textured surface 304 of the object 302. For example, based on one or more inputs 222 from the design output component 206 and/or the control component 208, the sheet material fabrication system 212 forms the textured surface 404 on the sheet material 402. The sheet material fabrication system 212 may form the textured surface 404 through one or more techniques such as machining, molding, etching, embossing, laser-texturing, sand blasting, computer numerical control (CNC) texturing, and/or another technique.

Based on one or more inputs 222 from the design output component 206 and/or the control component 208, the sheet material fabrication system 212 may separate (e.g., cut) the sheet material 402 into sections respectively corresponding to the second portions 310, 312, and 314 of the object 302. In addition, based on one or more inputs 222 from the design output component 206 and/or the control component 208, the sheet material fabrication system 212 may identify sub-portions (e.g., sub-portions 406a-406d) of one of more of the second portions (e.g., second portions 310 and 314) to facilitate attachment of sheet material 402 to the second portions 310-314 of the object 302. For example, the sheet material fabrication system 212 may separate (e.g., cut) the sheet material 402 into the sub-portions 406a and 406b corresponding to second portion 310, sub-portions 406c and 406d corresponding to second portion 314, and a portion 408 corresponding to second portion 312. The design output component 206, the control component 208, and/or the sheet material fabrication system 212 may designate sub-portions of the second portions based on the surface curvatures of the second portions of the object 302. In some implementations, the sheet material fabrication system 212 may use sensors and/or algorithms to identify the different regions of the sheet material 402. The design output component 206, the control component 208, and/or the sheet material fabrication system 212 may generate a virtual map of the sheet material 402, highlighting the areas where the sub-portions 406a-406d and the portion 408 of the sheet material 402 can be attached to the second portions 310-314 of the object 302.

FIG. 4 is provided as an example. Other examples may differ from what is described with regard to FIG. 4.

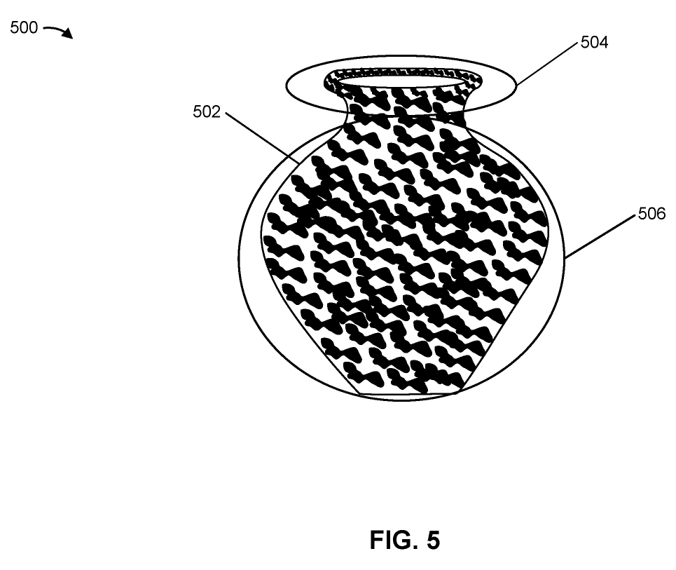

FIG. 5 illustrates an example implementation 500 of a 3D printed object 502 including a first portion 504 (e.g., corresponding to the first portion 308) and a second portion 506 (e.g., corresponding to second portions 310-314). The first portion 504 was 3D printed by a 3D printing system (e.g., 3D printing system 210) with a textured surface, and the second portion 506 was 3D printed by a 3D printing system (e.g., 3D printing system 210) without a textured surface. Sheet material comprising a texture (e.g., sheet material 402 including sub-portions 406a-406d, and portion 408) was fixed to the second portion 506 by, for example, a material handling and fixation system (e.g., material handling and fixation system 214).

FIG. 5 is provided as an example. Other examples may differ from what is described with regard to FIG. 5.

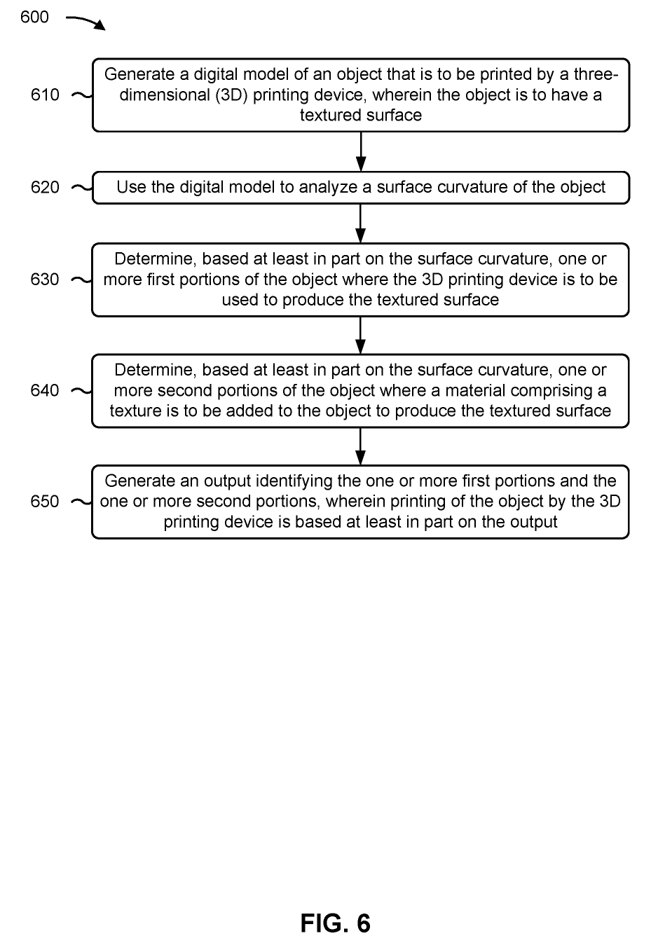

FIG. 6 is a flowchart of an example process 600 associated with managing fabrication of textured 3D printed objects. One or more process blocks of FIG. 6 are performed by a computer (e.g., computer 102 including 3D printed object design and fabrication code 150) and/or by another device or a group of devices separate from or including the computer, such as a 3D printing system (e.g., 3D printing system 210), a sheet material fabrication system (e.g., sheet material fabrication system 212), and/or a material handling and fixation system (e.g., material handling and fixation system 214). Additionally, or alternatively, one or more process blocks of FIG. 6 may be performed by one or more components of the computer 102, such as the processor set 114, communication fabric 116, volatile memory 118, persistent storage 120, operating system 130, peripheral device set 122, and/or network module 124.

As shown in FIG. 6, process 600 includes generating a digital model of an object that is to be printed by a 3D printing device, wherein the object is to have a textured surface (block 610). For example, the computer may generate a digital model of an object that is to be printed by a 3D printing device, wherein the object is to have a textured surface, as described above.

As further shown in FIG. 6, process 600 includes using the digital model to analyze a surface curvature of the object (block 620). For example, the computer may use the digital model to analyze a surface curvature of the object, as described above.

As further shown in FIG. 6, process 600 includes determining, based at least in part on the surface curvature, one or more first portions of the object where the 3D printing device is to be used to produce the textured surface (block 630). For example, the computer may determine, based at least in part on the surface curvature, one or more first portions of the object where the 3D printing device is to be used to produce the textured surface, as described above.

As further shown in FIG. 6, process 600 includes determining, based at least in part on the surface curvature, one or more second portions of the object where a material comprising a texture is to be added to the object to produce the textured surface (block 640). For example, the computer may determine, based at least in part on the surface curvature, one or more second portions of the object where a material comprising a texture is to be added to the object to produce the textured surface, as described above.

As further shown in FIG. 6, process 600 includes generating an output identifying the one or more first portions and the one or more second portions, wherein printing of the object by the 3D printing device is based at least in part on the output (block 650). For example, the computer may generate an output identifying the one or more first portions and the one or more second portions, wherein printing of the object by the 3D printing device is based at least in part on the output, as described above. In some aspects, printing of the object by the 3D printing device is based at least in part on the output.

Process 600 may include additional aspects, such as any single aspect or any combination of aspects described below and/or in connection with one or more other processes described elsewhere herein.

In a first aspect, generating the digital model comprises generating a mesh model of the object, wherein the mesh model is used to analyze the surface curvature of the object.

In a second aspect, alone or in combination with the first aspect, process 600 includes applying one or more computer vision techniques to the mesh model to identify a level of the surface curvature for one or more areas of the object.

In a third aspect, alone or in combination with one or more of the first and second aspects, process 600 includes applying one or more computer vision techniques to the mesh model to compute a plurality of normal vectors for a plurality of points on a surface of the digital model, and analyzing the plurality of normal vectors to compute a respective curvature at each of the plurality of points.

In a fourth aspect, alone or in combination with one or more of the first through third aspects, determining the one or more first portions and determining the one or more second portions are further based at least in part on a machine learning analysis by a machine learning algorithm, wherein the machine learning algorithm is trained with a dataset comprising at least one of manufacturing time data, manufacturing cost data, or material usage data for a plurality of operations in which objects with textured surfaces were 3D printed.

In a fifth aspect, alone or in combination with one or more of the first through fourth aspects, determining the one or more first portions and determining the one or more second portions comprises utilizing one or more image segmentation algorithms to divide the digital model into the one or more first portions and the one or more second portions.

In a sixth aspect, alone or in combination with one or more of the first through fifth aspects, process 600 includes identifying, based at least in part on the surface curvature, a plurality of sub-portions into which the one or more second portions are to be divided, wherein the output identifies the plurality of sub-portions, and wherein the material comprising the texture that is to be added to the object is cut into the plurality of sub-portions based at least in part on the output.

In a seventh aspect, alone or in combination with one or more of the first through sixth aspects, process 600 includes inputting, to the 3D printing device, data specifying the one or more first portions and data specifying the one or more second portions, wherein, based on the data specifying the one or more first portions, the 3D printing device is configured to 3D print the one or more first portions of the object including the textured surface, and wherein, based on the data specifying the one or more second portions, the 3D printing device is configured to 3D print the one or more second portions of the object without the textured surface.

In an eighth aspect, alone or in combination with one or more of the first through seventh aspects, process 600 includes inputting, to a sheet material fabrication device, the data specifying the one or more second portions, wherein, based on the data specifying the one or more second portions, the sheet material fabrication device is configured to fabricate the material comprising the texture.

In a ninth aspect, alone or in combination with one or more of the first through eighth aspects, process 600 includes controlling operation of a system to apply the material comprising the texture to the one or more second portions of the object that were 3D printed by the 3D printing device.

In a tenth aspect, alone or in combination with one or more of the first through ninth aspects, the controlling is based at least in part on feedback data including at least one of pressure data or temperature data corresponding to application of the material comprising the texture to the one or more second portions of the object.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

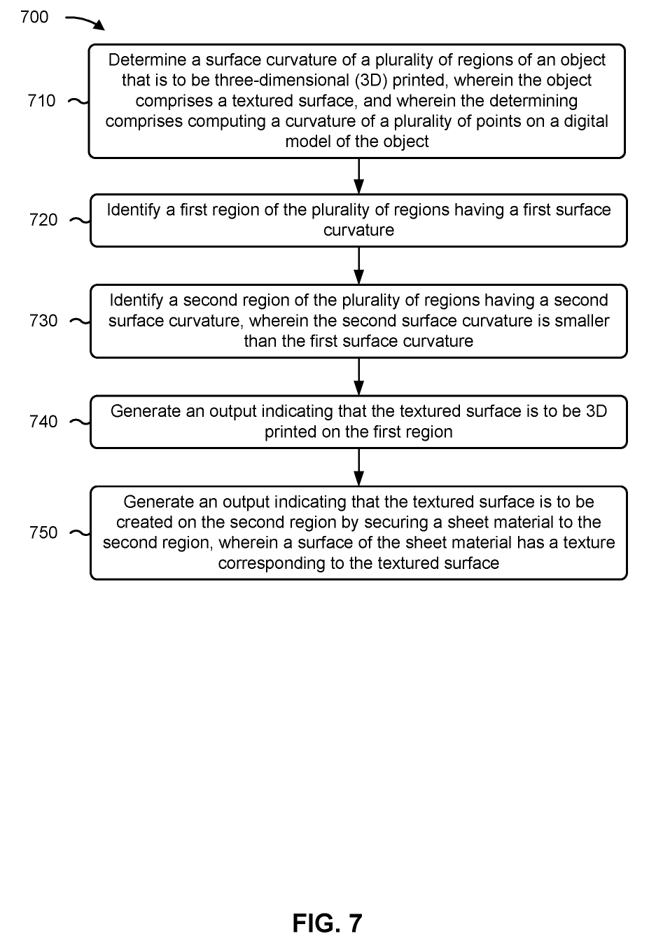

FIG. 7 is a flowchart of an example process 700 associated with managing fabrication of textured 3D printed objects. One or more process blocks of FIG. 7 are performed by a computer system (e.g., computer 102 including 3D printed object design and fabrication code 150) and/or by another device or a group of devices separate from or including the computer system, such as a 3D printing system (e.g., 3D printing system 210), a sheet material fabrication system (e.g., sheet material fabrication system 212), and/or a material handling and fixation system (e.g., material handling and fixation system 214). Additionally, or alternatively, one or more process blocks of FIG. 7 may be performed by one or more components of the computer 102, such as the processor set 114, communication fabric 116, volatile memory 118, persistent storage 120, operating system 130, peripheral device set 122, and/or network module 124.

As shown in FIG. 7, process 700 includes determining a surface curvature of a plurality of regions of an object that is to be 3D printed, wherein the object comprises a textured surface, and wherein the determining comprises computing a curvature of a plurality of points on a digital model of the object (block 710). For example, the computer system may determine a surface curvature of a plurality of regions of an object that is to be 3D printed, wherein the object comprises a textured surface, and wherein the determining comprises computing a curvature of a plurality of points on a digital model of the object, as described above. In some aspects, the object comprises a textured surface. In some aspects, the determining comprises computing a curvature of a plurality of points on a digital model of the object.

As further shown in FIG. 7, process 700 includes identifying a first region of the plurality of regions having a first surface curvature (block 720). For example, the computer system may identify a first region of the plurality of regions having a first surface curvature, as described above.

As further shown in FIG. 7, process 700 includes identifying a second region of the plurality of regions having a second surface curvature, wherein the second surface curvature is smaller than the first surface curvature (block 730). For example, the computer system may identify a second region of the plurality of regions having a second surface curvature, wherein the second surface curvature is smaller than the first surface curvature, as described above. In some aspects, the second surface curvature is smaller than the first surface curvature.

As further shown in FIG. 7, process 700 includes generating an output indicating that the textured surface is to be 3D printed on the first region (block 740). For example, the computer system may generate an output indicating that the textured surface is to be 3D printed on the first region, as described above.

As further shown in FIG. 7, process 700 includes generating an output indicating that the textured surface is to be created on the second region by securing a sheet material to the second region, wherein a surface of the sheet material has a texture corresponding to the textured surface (block 750). For example, the computer system may generate an output indicating that the textured surface is to be created on the second region by securing a sheet material to the second region, wherein a surface of the sheet material has a texture corresponding to the textured surface, as described above. In some aspects, a surface of the sheet material has a texture corresponding to the textured surface.

Process 700 may include additional aspects, such as any single aspect or any combination of aspects described below and/or in connection with one or more other processes described elsewhere herein.

In a first aspect, process 700 includes controlling a 3D printing system to 3D print the first region and to 3D print the textured surface on the first region, and controlling the 3D printing system to 3D print the second region with a non-textured surface.

In a second aspect, alone or in combination with the first aspect, process 700 includes controlling a sheet material fabrication system to produce the sheet material with the texture corresponding to the textured surface.

In a third aspect, alone or in combination with one or more of the first and second aspects, process 700 includes controlling a fixation system to fix the sheet material to the non-textured surface of the second region, wherein the controlling is based at least in part on feedback from one or more sensors.

In a fourth aspect, alone or in combination with one or more of the first through third aspects, controlling the fixation system comprises at least one of controlling a pressure being applied to the sheet material and to the non-textured surface of the second region during a securing operation, or controlling a temperature of the sheet material and of the non-textured surface of the second region during the securing operation.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

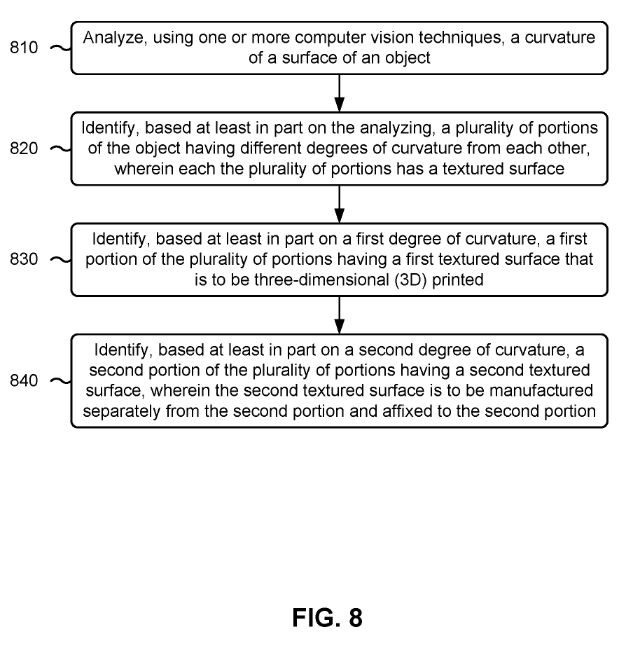

FIG. 8 is a flowchart of an example process 800 associated with managing fabrication of textured 3D printed objects. One or more process blocks of FIG. 8 are performed by a computer product (e.g., computer 102 including 3D printed object design and fabrication code 150) and/or by another device or a group of devices separate from or including the computer product, such as a 3D printing system (e.g., 3D printing system 210), a sheet material fabrication system (e.g., sheet material fabrication system 212), and/or a material handling and fixation system (e.g., material handling and fixation system 214). Additionally, or alternatively, one or more process blocks of FIG. 8 may be performed by one or more components of the computer 102, such as the processor set 114, communication fabric 116, volatile memory 118, persistent storage 120, operating system 130, peripheral device set 122, and/or network module 124.

As shown in FIG. 8, process 800 includes analyzing, using one or more computer vision techniques, a curvature of a surface of an object (block 810). For example, the computer product may analyze, using one or more computer vision techniques, a curvature of a surface of an object, as described above.

As further shown in FIG. 8, process 800 includes identifying, based at least in part on the analyzing, a plurality of portions of the object having different degrees of curvature from each other, wherein each the plurality of portions has a textured surface (block 820). For example, the computer product may identify, based at least in part on the analyzing, a plurality of portions of the object having different degrees of curvature from each other, wherein each the plurality of portions has a textured surface, as described above. In some aspects, each the plurality of portions has a textured surface.

As further shown in FIG. 8, process 800 includes identifying, based at least in part on a first degree of curvature, a first portion of the plurality of portions having a first textured surface that is to be 3D printed (block 830). For example, the computer product may identify, based at least in part on a first degree of curvature, a first portion of the plurality of portions having a first textured surface that is to be 3D printed, as described above.

As further shown in FIG. 8, process 800 includes identifying, based at least in part on a second degree of curvature, a second portion of the plurality of portions having a second textured surface, wherein the second textured surface is to be manufactured separately from the second portion and affixed to the second portion (block 840). For example, the computer product may identify, based at least in part on a second degree of curvature, a second portion of the plurality of portions having a second textured surface, wherein the second textured surface is to be manufactured separately from the second portion and affixed to the second portion, as described above. In some aspects, the second textured surface is to be manufactured separately from the second portion and affixed to the second portion.

Process 800 may include additional aspects, such as any single aspect or any combination of aspects described below and/or in connection with one or more other processes described elsewhere herein.

In a first aspect, identifying the first portion and identifying the second portion are further based at least in part on an analysis by one or more machine learning models of historical data selected from the group consisting of manufacturing time, manufacturing cost, and material usage associated with 3D printing of objects having textured surfaces.

In a second aspect, alone or in combination with the first aspect, the computer vision techniques are selected from the group consisting of point cloud processing techniques, structured light techniques, photometric stereo techniques, edge detection, corner detection, and feature point extraction.

In a third aspect, alone or in combination with one or more of the first and second aspects, process 800 includes classifying the plurality of portions based on the different degrees of curvature, and using the classifications to identify the first portion and the second portion.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
generating a digital model of an object that is to be printed by a three-dimensional (3D) printing device,
wherein the object is to have a textured surface;
using the digital model to analyze a surface curvature of the object;
determining, based at least in part on the surface curvature, one or more first portions of the object where the 3D printing device is to be used to produce the textured surface;
determining, based at least in part on the surface curvature, one or more second portions of the object where a material comprising a texture is to be added to the object to produce the textured surface; and
generating an output identifying the one or more first portions and the one or more second portions,
wherein printing of the object by the 3D printing device is based at least in part on the output.

2. The method of claim 1, wherein generating the digital model comprises generating a mesh model of the object, and
wherein the mesh model is used to analyze the surface curvature of the object.

3. The method of claim 2, further comprising applying one or more computer vision techniques to the mesh model to identify a level of the surface curvature for one or more areas of the object.

4. The method of claim 2, further comprising:
applying one or more computer vision techniques to the mesh model to compute a plurality of normal vectors for a plurality of points on a surface of the digital model; and
analyzing the plurality of normal vectors to compute a respective curvature at each of the plurality of points.

5. The method of claim 1, wherein determining the one or more first portions and determining the one or more second portions are further based at least in part on a machine learning analysis by a machine learning algorithm, and
wherein the machine learning algorithm is trained with a dataset comprising at least one of manufacturing time data, manufacturing cost data, or material usage data for a plurality of operations in which objects with textured surfaces were 3D printed.

6. The method of claim 1, wherein determining the one or more first portions and determining the one or more second portions comprises utilizing one or more image segmentation algorithms to divide the digital model into the one or more first portions and the one or more second portions.

7. The method of claim 1, further comprising:
identifying, based at least in part on the surface curvature, a plurality of sub-portions into which the one or more second portions are to be divided,
wherein the output identifies the plurality of sub-portions, and
wherein the material comprising the texture that is to be added to the object is cut into the plurality of sub-portions based at least in part on the output.

8. The method of claim 1, further comprising:
inputting, to the 3D printing device, data specifying the one or more first portions and data specifying the one or more second portions,
wherein, based on the data specifying the one or more first portions, the 3D printing device is configured to 3D print the one or more first portions of the object including the textured surface, and
wherein, based on the data specifying the one or more second portions, the 3D printing device is configured to 3D print the one or more second portions of the object without the textured surface.

9. The method of claim 8, further comprising:
inputting, to a sheet material fabrication device, the data specifying the one or more second portions,
wherein, based on the data specifying the one or more second portions, the sheet material fabrication device is configured to fabricate the material comprising the texture.

10. The method of claim 9, further comprising controlling operation of a system to apply the material comprising the texture to the one or more second portions of the object that were 3D printed by the 3D printing device.

11. The method of claim 10, wherein the controlling is based at least in part on feedback data including at least one of pressure data or temperature data corresponding to application of the material comprising the texture to the one or more second portions of the object.

12. A computer system comprising:
a processor set;
one or more computer-readable storage media; and
program instructions stored on the one or more computer-readable storage media to cause the processor set to perform operations comprising:
determining a surface curvature of a plurality of regions of an object that is to be three-dimensional (3D) printed,
wherein the object comprises a textured surface, and
wherein the determining comprises computing a curvature of a plurality of points on a digital model of the object;
identifying a first region of the plurality of regions having a first surface curvature;
identifying a second region of the plurality of regions having a second surface curvature,
wherein the second surface curvature is smaller than the first surface curvature;
generating an output indicating that the textured surface is to be 3D printed on the first region; and
generating an output indicating that the textured surface is to be created on the second region by securing a sheet material to the second region,
wherein a surface of the sheet material has a texture corresponding to the textured surface.

13. The computer system of claim 12, wherein the operations further comprise:
controlling a 3D printing system to 3D print the first region and to 3D print the textured surface on the first region; and
controlling the 3D printing system to 3D print the second region with a non-textured surface.

14. The computer system of claim 13, wherein the operations further comprise:
controlling a sheet material fabrication system to produce the sheet material with the texture corresponding to the textured surface.

15. The computer system of claim 14, wherein the operations further comprise:
controlling a fixation system to fix the sheet material to the non-textured surface of the second region,
wherein the controlling is based at least in part on feedback from one or more sensors.

16. The computer system of claim 15, wherein controlling the fixation system comprises at least one of controlling a pressure being applied to the sheet material and to the non-textured surface of the second region during a securing operation, or controlling a temperature of the sheet material and of the non-textured surface of the second region during the securing operation.

17. A computer program product comprising:
one or more computer-readable storage media; and
program instructions stored on the one or more computer-readable storage media to perform operations comprising:
analyzing, using one or more computer vision techniques, a curvature of a surface of an object;
identifying, based at least in part on the analyzing, a plurality of portions of the object having different degrees of curvature from each other,
wherein each the plurality of portions has a textured surface;
identifying, based at least in part on a first degree of curvature, a first portion of the plurality of portions having a first textured surface that is to be three-dimensional (3D) printed; and
identifying, based at least in part on a second degree of curvature, a second portion of the plurality of portions having a second textured surface,
wherein the second textured surface is to be manufactured separately from the second portion and affixed to the second portion.

18. The computer program product of claim 17, wherein identifying the first portion and identifying the second portion are further based at least in part on an analysis by one or more machine learning models of historical data selected from the group consisting of manufacturing time, manufacturing cost, and material usage associated with 3D printing of objects having textured surfaces.

19. The computer program product of claim 17, wherein the computer vision techniques are selected from the group consisting of point cloud processing techniques, structured light techniques, photometric stereo techniques, edge detection, corner detection, and feature point extraction.

20. The computer program product of claim 17, wherein the operations further comprise:
classifying the plurality of portions based on the different degrees of curvature; and
using the classifications to identify the first portion and the second portion.
